(19) United States
(12) Patent Application Publication
(10) Pub. No.: US 2025/0347522 A1
(43) Pub. Date: Nov. 13, 2025

(54) NAVIGABLE CUSTOM ROUTES

(71) Applicant: Apple Inc., Cupertino, CA (US)

(72) Inventors: Mrinmayee P. Hingolikar, Sunnyvale, CA (US); Ryan Dignard, Piedmont, CA (US); Tobias Zuendorf, Santa Clara, CA (US); Wesley K. Yue, Dublin, CA (US); Thomas Pajor, Cupertino, CA (US); Zao Huang, Oakland, CA (US); Michael T. Wegner, Dübendorf (CH); Moritz Baum, Karlsruhe (DE)

(73) Assignee: Apple Inc., Cupertino, CA (US)

(21) Appl. No.: 19/205,966

(22) Filed: May 12, 2025

Related U.S. Application Data
(60) Provisional application No. 63/646,610, filed on May 13, 2024.

(51) Int. Cl. G01C 21/34; G01C 21/36

(52) U.S. Cl. CPC G01C 21/3415; G01C 21/3423; G01C 21/3626; G01C 21/3694

(57) ABSTRACT

Aspects of the disclosed technology include checking a route which has been previously generated or stored on a user device to check whether the route can be currently navigated. Aspects include sending, from a user device to a server, route data which may include route segments and/or anchor points. Each route segment may be checked to see if it can be currently navigated. The server may return an alternative route, with replacement route segments, for parts of the route which may not be navigated.

### CROSS-REFERENCES TO OTHER APPLICATIONS

This application claims priority to U.S. Provisional Application No. 63/646,610, for “NAVIGABLE CUSTOM ROUTES” filed on May 13, 2024, which is herein incorporated by reference in its entirety for all purposes.

### BACKGROUND

Mobile, electronic maps and associating routing functionality may include a computer-generated map with one or more defined points of interests, which are often viewed on a user's mobile device. These points of interest may be used to generate or may be included within a route, which can also be viewed on the user's mobile device. These routes may be generated locally on the device, and therefore may be stored there as well. Because of this, a stored route may become outdated or stale, e.g., unnavigable due to road closures, changed terrain, closed roads at various times of a day etc. Thus, challenges clearly exist with keeping locally generated maps up to date.

### BRIEF DESCRIPTION OF THE DRAWINGS

FIG. 1 illustrates a system and a process for map updates, according to certain embodiments.

FIGS. 2A-2E illustrate a system for map updates, according to certain embodiments.

FIG. 3 illustrates a flowchart of a workflow for route management, according to certain embodiments.

FIG. 4 illustrates a diagram of a method for route management, according to certain embodiments.

FIG. 5 illustrates an example architecture or environment configured to implement techniques relating to providing route management, according to certain embodiments.

### DETAILED DESCRIPTION

Current technologies predominantly focus on providing routes for vehicular travel or basic pedestrian pathways, often neglecting the specialized needs where users may require more personalized route creation and dynamic navigation capabilities. Traditional navigation systems may be designed to select the fastest or shortest route based on pre-existing, static road or trail networks and may not be optimized for allowing users to interactively modify or create routes based on personal preferences and/or real-time environmental conditions.

Additionally, a user may want to navigate with some other priority (as opposed to the fastest route, the shortest route, etc.). For example, a user may want to sightsee, take a scenic route through an area, take a route which contains specific points at specific times, etc. The experience of the journey may be more important to the user—the time spent or distance travelled may be less important. As opposed to a trip or route that largely follows well established, travelled, and/or maintained roads and highways, scenic journeys may pass through less travelled areas and/or may include specific viewpoints or other target locations that are not part of the most efficient route.

Current technologies for providing routes generally rely on the availability of an Internet connection and the availability of an online service to provide a route. The online service may interpret a request between two or more points, and provide routing information based on the traffic, weather, or other real time conditions at that point of time. The evaluation of the route may be performed at a server. The server (or other online routing or map service) may focus only on obtaining a route between a starting and endpoint, and may not consider information (including paths or route segments) which may have already be saved on a user device. Thus, current technology only focuses on providing the quickest, most fuel efficient, or cheapest route (e.g., avoiding tolls), without consideration for the current availability of individual segments of the route. For example, when requesting a route between two points (or even multiple points), a server may receive a request and return a route based on optimizing for time or distance (with certain constraints, such as for not using highways or avoiding tolls). Each time a route is generated between the points, the route information is generated each time at the server and then sent to the user device. The route between the two points may also change each time based on the current traffic conditions. Thus, current technologies for navigation focus solely on quickest or most efficient routing between the points, but may not be configured to receive any other information from a user device related to the route in determining navigation.

Additionally, current technologies are not able to consider evaluating an existing route which may be stored on a user device. A stored route on a user device may contain a number of points of interest and a number of route segments to navigate between those points of interest. Current technologies are unable to consider this information, which may not be the most efficient, but is valuable to a user in terms of a user's experience in navigating a route. For example, a user may only want to know if a route which he or she has previously saved onto his or her user device, or previously traversed, is still able to be navigated. For example, a saved route may contain a curated route which has been previously saved or downloaded to a user device. The user may want to navigate the saved route as closely as possible, but prior to starting the route, may want to know if the route may be navigated.

For example, a saved route may contain a number of points of interest (in some examples, referred to as anchor points) as well as specific route segments which connect the points of interest. For example, the saved route may be from a list of curated routes which have been downloaded to a user device. Each curated route may contain a specific set of points of interest, and a set of specific paths, which may be defined by route segments, to take to reach the points of interest. Upon selection of the route, a user may wish not to have the most efficient route between the points, but only check whether the existing route may be navigated. Stated alternatively, the user may desire to navigate through the saved route by following the existing route segments as closely as possible. The user may only wish to check whether the route segments have been affected due to closure, weather, or other conditions.

Additionally, a saved route may be a route which has been defined by a user. For example, a user may take a specific area of a map, and add one or more anchor points, define a specific route between those anchor points, and save the route to his or her user device or user profile. In another example, a user may take an existing route and add or remove specific route segments and/or anchor points. As one example, a user who wishes to go hiking may take a curated route which is downloaded to his or her user device, modify the route by changing one or more anchor points, and also define a custom path between one or more anchor points (e.g., defining a path with route segments which are more scenic, such as next to a lake or river).

In some embodiments, a user may define or sketch a route and anchor points on a user device which is offline and not connected to a server. This offline route may still be saved to the user device and route segments may be approximated. As further discussed below, this information may still be provided to a server to be checked, which may return a route with route segments which most closely approximate the provided route.

Embodiments of the disclosed technology may include transmission of information related to the saved routes (e.g., an ordered list of the route segments) to a server or other computing device to check whether each route segment may be traversed or navigated. The server may contain updated information related to terrain, weather advisories, route segments, or other rules related to the route (e.g., a closure of a particular route segment or anchor point at a specific time). Upon receipt of the information, the server may check the received route segments and/or anchor points using a route service which may utilize information from one or more databases to assess the viability and/or navigability of the route provided.

The route service may check each route segment provided to it. If each route segment may be navigated, the server may return a confirmation message to the user device, indicating that the route is navigable. In some embodiments, if only a small section of the route provided is not navigable, the server may provide alternative route segments to complete the route and avoid the segments which may not be navigated. The alternative route segments may be chosen to minimize variation from the current route segments. In some examples, even if one of the route segments is navigable, alternative route segments may replace those navigable route segments to preserve the overall route or minimize the overall variation from the route provided by the user device.

The server may also provide information about why a particular route segment and/or anchor points is not accessible (e.g., it may be closed due to time of day or closed due to snowfall). In some examples, if a threshold amount of the route is not navigable (e.g., more than 20% by distance of the route), an error message or other message may be returned by the server. A user may then provide additional input to request that alternatives be provided. Additionally, as explained herein, whether or not a route segment is navigable may depend on the mode of transportation selected or provided by the user (e.g., a route may be open to walking or biking, but not to driving, or the like).

The server may also provide a “navigable” message or other confirmatory message with respect to route segments which are available to navigate. To save bandwidth or data, the server may also only provide (e.g., in its message to the user device) a list of route segments which have been replaced, and the new route segments which replace those segments to complete the route. In some examples, this may be done in more than one stage, allowing a route to be initiated while replacement route segments are being downloaded or obtained.

Further, in some use cases, such as during hiking or traveling in remote area, wireless network coverage on these routes may also be restricted as compared to the more travelled routes. While 5G coverage may be available on a highway, for example, on a back road of a scenic route, only 3G may be available. Furthermore, a signal strength of the network coverage may be weaker, only allowing for a fewer number of data packets to be transmitted over a period of time or small data packets to be successfully transmitted and received by the user device with high reliability. During a typical mapping and routing operation (e.g., when the user device has a strong wireless connection), the user device and the service may exchange a large amount of data. However, at least some of the data may not be applicable during a scenic route (e.g., live traffic data). Thus, there is a need to not only generate a route by factors other than speed and distance, but also to exchange mapping and routing information in a lightweight, efficient manner. Additionally, as only a subset of information needs to be updated and provided to the user device, the server may provide only the required updates to a saved route (e.g., route information corresponding to updated route segments which differ from the provided route segments). In some examples, this process can be further be enhanced through the use of segment IDs to uniquely identify the changed route segments.

One solution may be for a map application executed on the user device to access a desired route. The desired route may be generated by a user of the user device, stored locally on the user device, and/or accessed from some external source (e.g., a server). The map application may then transmit data to a routing service executed on a computing system. The data may include indicators of one or more segments of the desired route, each identified with a respective segment ID. A segment or route segment may refer to a portion and/or a segment of a route. A route segment may have been previously generated or calculated. For example, a route segment may be defined by GPS coordinates or other map coordinates. A segment ID may be a unique identifier which corresponds to a segment of a route or the specific route segment. The routing service may then access data associated with the desired route and/or the respective segment IDs to determine the navigability of each segment of the desired route. Based on the navigability of each segment of the desired route, the routing service may then generate a second route. The second route may include points of the first route, indicated in the data, but may include none, some, or all of the segments of the desired route. The routing service may then transmit data indicating the second route to the user device.

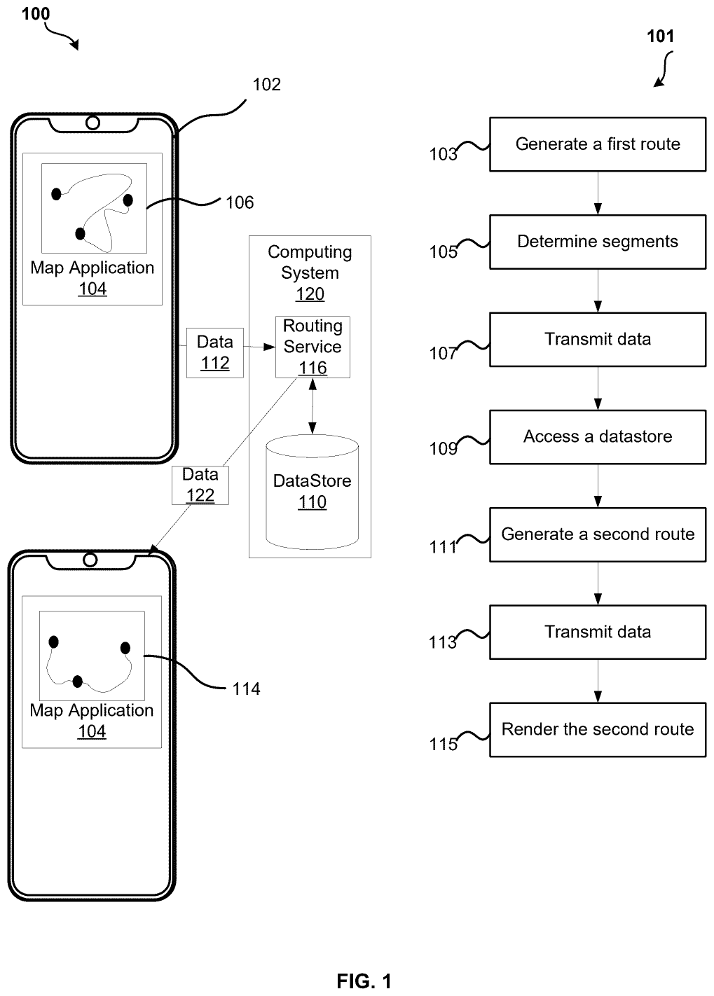

FIG. 1 illustrates a system 100 and a process 101 for generating or updating routes, according to certain embodiments. The system 100 may include a user device 102 with a map application 104 and a computing system 120. The computing system 120 may include a routing service 116 and a datastore 110. The user device 102 may be a mobile device, phone, computer, laptop, tablet, point of sale system, or any other suitable device. The user device 102 may include functionality to receive input from a user, such as through a touchscreen, stylus, peripheral device (e.g., a mouse), and/or any other such input means.

The map application 104 may be configured to access, generate, and/or display maps and/or routing information on a display of the user device 102. One or more routes may be stored on the user device 102. The routes may include various points such as start points, end points, points associated with a desired location, and other such information. These points may be referred to as “anchor points.” Each of the anchor points may correspond to a real-world location and be identifiable by latitude and longitude, addresses, and other such information. A particular route may also include roads, trails, highways, etc. connecting at least two of the anchor points for included in the particular route. Whereas an anchor point may be identifiable using a street address, a segment of road used to connected the anchor point to another anchor point may be identified by a segment ID. Thus, each of the routes may include a plurality of anchor points and at least one segment (e.g., identified by a corresponding segment ID).

In an example, the map application 104 may be configured to accept user inputs to generate a route. A user of the user device 102 may provide an input (e.g., tapping, swiping, touchscreen gestures, etc.) within the map application 104. The input may indicate one or more anchor points such as a start point, end point, and scenic point along the way. The input (or another input) may also indicate a desired route (e.g., drawing a line between two or more of the anchor point). The map application 104 may then process the inputs to generate a route geometry and/or segments of the desired route. The route geometry may be an inexact representation of the desired route, not necessarily including road, paths, etc. that may make the desired route (and/or segments thereof) navigable. In some examples, the route geometry may be used to “snap” or “fit” onto (e.g., as an overlay of) a pre-generated map. Once the route geometry is provided to a user device, the UI of the user device may update the representation of the map to include the route geometry over the underlying map representation.

In other examples, the map application 104 may access stored routes and/or route geometries. The stored routes may stored on a memory device of the user device 102, or may be stored on a server, a cloud-based system, or any other external system or device. This includes routes that are historically significant, downloaded for offline use, generated by other users, etc. Furthermore, the map application 104 may display an option for the user to select a stored) or generated route and convert the stored route to a navigable route. The map application 104 may perform additional functions to ensure that that selected route is currently navigable.

The map application 104 may also support the creation of a route between the selected points to assist with a visualization of one (or more) potential route(s) between the provided points. As further explained herein, the map application 104 may later be used in connection with one or more processes or techniques for generating a route or validation of a route. The simplified route may be based on estimations made by the user application.

The routing service 116 may include hardware and/or software components, executed on the computing system 120. The routing service 116 may process data received from the map application 104 to generate actionable, navigable, and/or updated routes. The routing service 116 may also provide functionality including route calculation, dynamic route updates, data optimization, conversion to a navigable route, etc. For example, upon receiving data from the user device 102, the routing service 116 may access the datastore 110 in order to determine the navigability of each segments identified in the received data. The routing service 116 may then determine one or more replacement segments for any unnavigable segment. The routing service 116 may then perform a routing calculation to generate a new route. In generating the new route, the routing service 116 may attempt to minimize a difference between the route received (e.g., the segments in the received data) from the user device 102 and the new route. For example, the routing service may attempt to minimize a difference in a number of paths (or roads, highways, etc.), a number of segments, and/or other such components of the desired route.

The datastore 110 may include various data sets used by the routing service 116 for route calculations. The datastore 110 may include geographic information, including maps of various areas, road networks, trails, and points of interest, vital for plotting routes. The datastore 110 may also include environmental data such as information about weather conditions, terrain types, seasonal information that might impact route accessibility (e.g., road or trail closures due to maintenance, weather conditions, etc.). Additionally, real-time traffic data may be maintained to facilitate the calculation of the fastest routes and to assist with rerouting decisions to avoid certain areas. The datastore 110 may also include historical user data, such as information on routes previously taken by the user, routes taken by other users, user preferences, user ratings, and other such characteristics of a route.

The routing service 116 may also include one or more algorithms for route calculation and optimization. For example, incorporating logic for processing the stored geographic and environmental data into actionable route plans. Furthermore, user-specific data such as saved routes, preferred settings, and historical navigation records are stored, enabling the system to tailor navigation experiences to individual user preferences and ensure settings and routes are automatically adjusted accordingly.

The datastore 110 may be structured using various database formats and systems to accommodate the diverse types of data it stores. The datastore 110 may include a variety of database formats and systems to manage its diverse data requirements effectively. Relational databases like PostgreSQL or MySQL may be used for structured data such as user accounts and historical navigation records. For information which requires more flexible and voluminous data storage, NoSQL databases like MongoDB or Cassandra may be chosen, which are well-suited for handling large datasets of environmental data or semi-structured map data. Geospatial databases such as PostGIS or Oracle Spatial and Graph may be used for storing and querying geographical and spatial information. In some examples, time-series databases like InfluxDB may be employed for continually updated data like traffic and environmental conditions. This may assist with optimizing the handling of time-stamped data. In some examples which require data distribution across multiple machines, distributed file systems may be implemented to manage data redundancy and scalability effectively. Graph databases may also be used to support the storage of road networks and points of interest, and in turn may facilitate efficient path computations. In some examples, for offline accessibility, SQLite or similar embedded databases may provide local data storage on devices, crucial for maintaining functionality in areas with limited connectivity. Any combination of these database formats may be included or used by the datastore 110 to adeptly handle various data types and processing needs.

The computing system 120 may include one or more components configured to perform some or all of the processes and methods described herein. The one or more computing systems may include one or more processors, computer-readable memories, and other such components. Some or all of the computing systems may be cloud-based systems and/or physical machines and devices. In various embodiments, the computing system 120 may be a cloud-based and virtual computing system, including scaling and orchestration functionality. For example, computing system 120 may include Kubernetes to automate deployment, scaling, and management of containerized applications.

The computing system 120 may include one or more components configured to perform some or all of the processes and methods described herein. The one or more computing systems may include one or more processors, computer-readable memories, and other such components.

At 103, a first route may be generated on user device 102. The first route may be generated via the map application 104. In some embodiments, generating the first route may include selecting one or more anchor points on the map 106, displayed by the map application 104. The generation of the first route may also include the selection of one or more segments or route fragments. For example, after selecting the one or more anchor points on the map 106, the user may draw a line connecting some or all of the anchor points. Additionally or alternatively, the line may include a bounding box, where a route is not to extend outside the bounding box. The line may include individual elements of a larger route which may be selected by the user. Additionally or alternatively, the generation of the route can include loading routes that have been previously saved or downloaded. Other input methods may be used to generate a first route. For example, a user may provide textual data that indicates that the route should include a point of interest which allows for a view of a sunset which is less than a certain distance from a current location. The map application 104 may then determine use this information to determine a start point and an end point, various other anchor points, and/or generate a route.

At 105, the map application 104 may determine one or more segments of the first route. The map application 104 may process the input received, and divide the route into one or more distinct segments. Each segment may be associated with a segment ID, uniquely identifying each segment. In some embodiments, the user device 102 (and/or the map application 104) may generate and assign the respective segment IDs. In other embodiments, the segment IDs may be universal (e.g., accessed by multiple user devices from a central server).

Determining the segments may include calculating a minimal set of paths which may connect input points based on one or more techniques. For example, an algorithm such as Dijkstra's algorithm may be used to find the shortest paths between two or more anchor points. In embodiments where such an algorithm is included in the map application 104 (or otherwise accessed), the first route and segments thereof may be performed offline. However, without accurate information (e.g., road conditions), the route generated offline may be at least partially inaccurate. Certain segments may be unknown or unavailable based on the information which is contained in user device 102. Thus, in some examples, the first route may be an estimation of a navigable route.

At 107, after the segments of the route are determined, the map application 104 or user device 102 may transmit data 112 to the routing service 116. The data 112 may be transmitted directly to the routing service 116, or may be transmitted to (and received by) some other component of the computing system 120. The computing system 120 may provide this data to routing service 116. The data 112 may include a list of anchor points associated with the first route, user preferences, route segments linking the anchor points, a bounding box, and/or other information.

At 109, the routing service 116 may access the datastore 110 to data associated with each of the segments identified in the data 112 and/or the anchor points. The data accessed by the routing service 116 may be used to complement the information indicated in the data 112, check statuses of each of the segments in the data 112, etc. For example, the datastore 110 may include weather reports for some or all of the segments included in the data 112. The routing service 116 may determine that a particular segment is likely inaccessible due to snow. The datastore 110 may also include maintenance records of one or more of the segments, and other such information. This can ensure that one or more route segments provided determined for the first route are navigable based on a check against information which may be included in the datastore 110.

At 111, the routing service 116 may generate a second route. The second route may be based at least in part on the data 112 (e.g., the first route). The second route may be based on updated environmental conditions, user preferences, time of day constraints, changes to the environment, terrain, changes to local regulations, the directionality of segments (e.g., if one segment can only be traversed one way but not the other, such as a steep hill), etc. The routing service 116 may attempt to include or keep as much of the first route as possible based on the map segments. If the second route was completely different to the first route, a user experience may be negatively impacted, frustrating the user. Thus, in generating the second route, the routing service 116 may attempt to maintain as many segments as possibly.

Based on the information accessed by the routing service 116 from the datastore 110, the routing service 116 may determine that particular some or all of the anchor points indicated in the data 112 are inaccessible. For example, an anchor point included in the first route (and therefore the data 112) may be a required anchor point (e.g., a user-designated requirement, a geographical requirement, etc.). If the required anchor point is inaccessible, a failure notification may be generated by the routing service 116. Similarly, if a number of segments and/or anchor points (non-required anchor points) are inaccessible, the routing service 116 may also generate the failure notification. In some examples, other information related to the second route, such as the times that the second route may be accessible.

At 113, once the second route has been generated and optimized by routing service 116, data 122 may be transmitted to the user device 102 and/or the map application 104. In some examples, this information may be optimized or compressed. For example, only those route segments that differ from the first route may be included in the data 122. Thus, the data 122 may be lightweight, and more easily accessible with a poor wireless connection. The different route segments (sometimes “replacement segments”) may include a separate segment ID and an indication of which segment of the first route they are replacing. . . . In some examples, if additional information related to the replacement segments may be required (e.g., geometry, time they may be accessed, etc.). The additional information may be transmitted by the routing service 116 (or some other component of the computing system 120) to the user device 102 at a later time (e.g., when the wireless connection is stronger).

At 115, the second route may be rendered. The rendering may include processing some or all of the data 122 in order to generate a second map 114. For example, the map application 104 may render the data 122 into a visually accessible format. Thus, the second map 114 may include a representation of the second route (and/or associated segments), interactive elements, layering information, inclusion of updates (e.g., what elements of a previously stored route (e.g., the first route) have changed), and other displays of information.

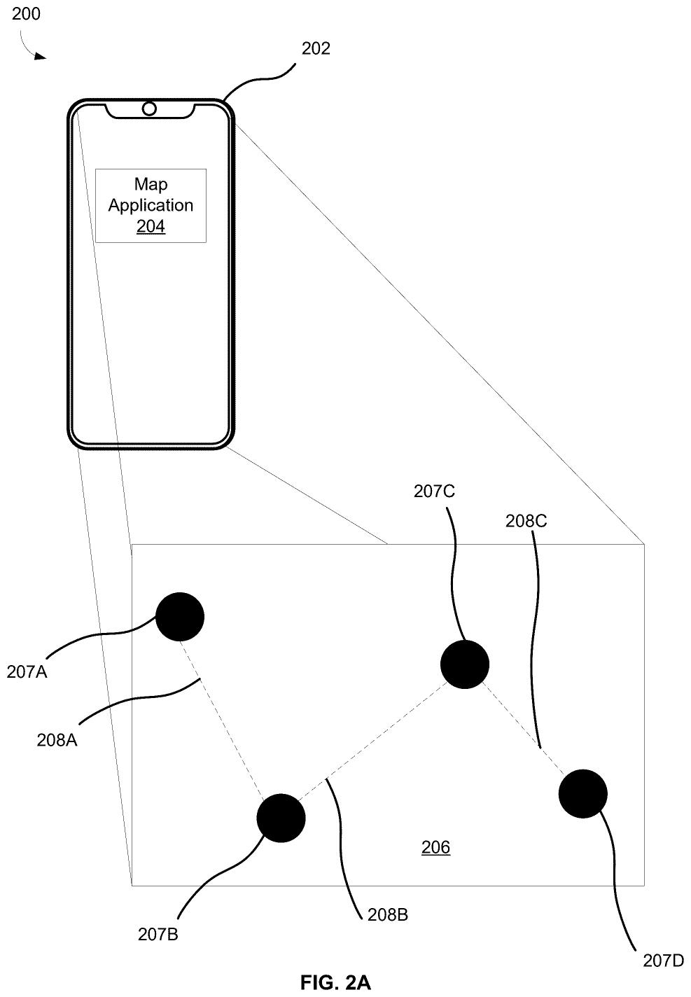

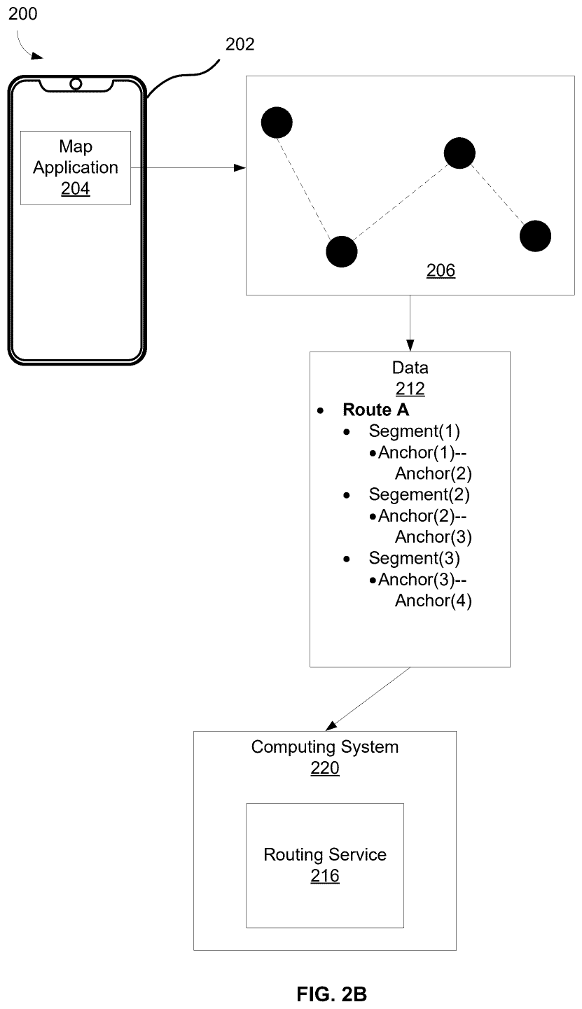

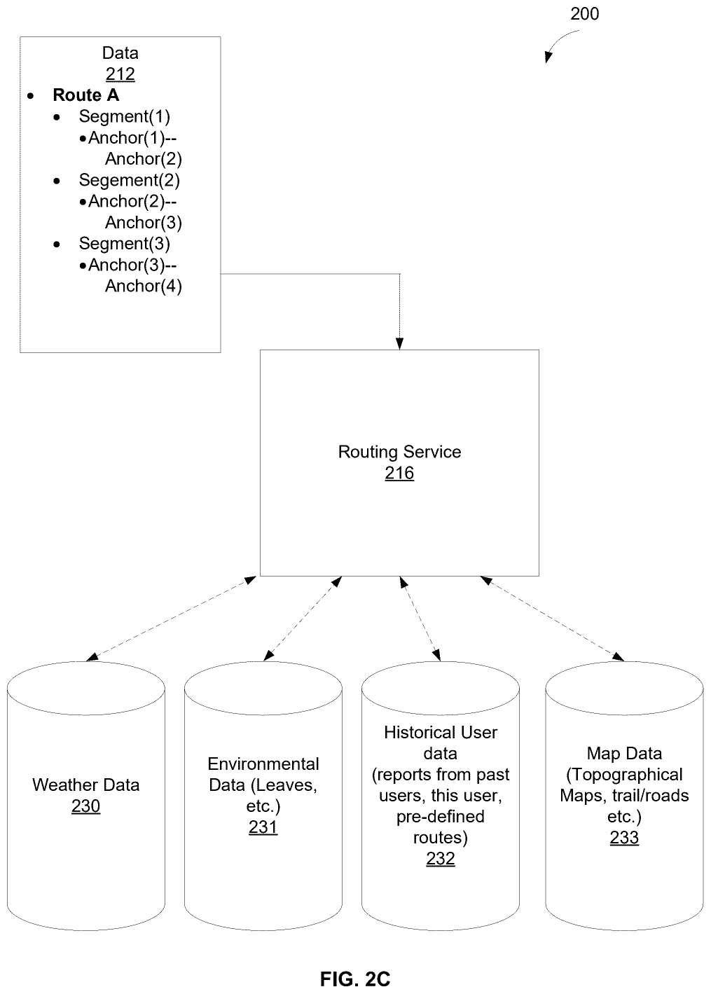

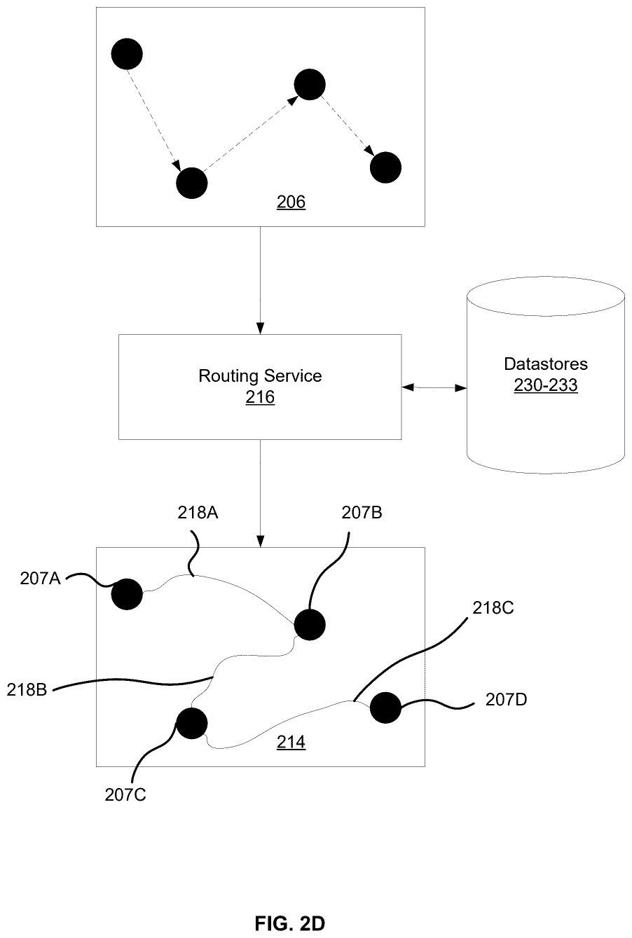

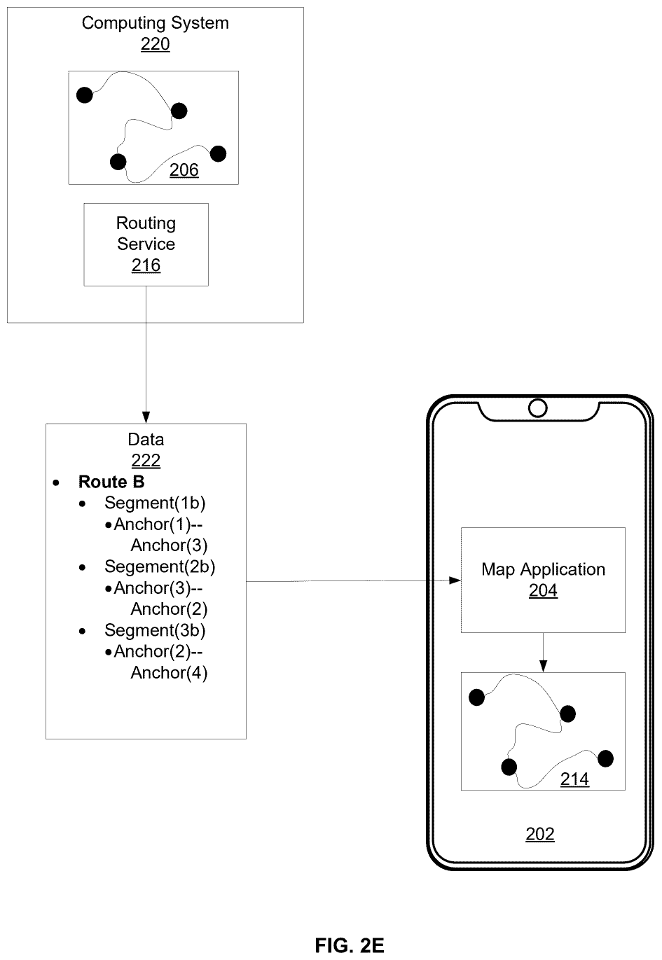

FIGS. 2A-2E illustrate a system 200 for route management, according to certain embodiments. The system 200 may be similar to some or all of the system 100 described in FIG. 1. The system 200 may include a user device 202 running an map application 204. The user device 202 may be similar to the user device 102 and the map application 204 may be similar to the map application 104. The user device 202 may include a mobile device, phone, computer, laptop, tablet, or any other suitable device.

The map application 204 may be similar to the map application 204. The map application 204 may be configured to access, generate, and/or display maps and/or routing information on a display of the user device 202. A user of the user device 102 may provide an input (e.g., tapping, swiping, touchscreen gestures, etc.) within the map application 204. The input may indicate one or more anchor points such as a start point, end point, and scenic point along the way. The input (or another input) may also indicate a desired route (e.g., drawing a line between two or more of the anchor point). The map application 204 may then process the inputs to generate a route geometry and/or segments of the desired route. The route geometry may be an inexact representation of the desired route, not necessarily including road, paths, etc. that may make the desired route (and/or segments thereof) navigable.

In the example shown in FIG. 2A, the map application 204 may display a map 206. The map 206 may be similar to map 106. The map 206 may be a representation of stored routes and/or a user generated route. The map 206 may contain anchor points, 207A, 207B, 207C, and 207D. Anchor points 207A-D may correspond to locations input by a user of the user device 202. For example, the user may tap a display of the user device 202. The map application 204 may then generate an anchor point (or representation thereof) on the map 206. The map application 204 may also determine one or more characteristics associated with the anchor points 207A-D. For example, the anchor point 207A may be a parking lot. The map application 204 may then determine a street address of the parking lot, GPS coordinates, and other such information. The anchor point 207B may be a mountain peak that the user wishes to see (e.g., while sightseeing). The mountain peak may not have an associated street address, so the map application 204 may determine GPS coordinates for the mountain peak. One of ordinary skill in the art would recognize many different possibilities and configurations.

The map 206 may include segments 208A-C between the anchor points 207A-207D. The segments 208A, 208B, and 208C may be generated between anchor points 207A-207D by the map application 204 (e.g., via an algorithm). Additionally or alternatively, the segments 208A-208C may be input by the user. Although illustrated as a straight line in FIG. 2A, the segments may take on other shapes or topologies. Additionally, each segment illustrated may further contain sub-segments, or additional segments, which may be used for the routing after conversion to a navigable route. The segments 208A-208C may correspond to roads, paths, etc., or may be a generally desired route.

In FIG. 2B, the map application 204 may determine information corresponding to the map 206 to generate data 212. The data 212 may include information indicating one or more features of the map 206. As shown in FIG. 2B, the data 212 may include a route name (here, “Route A”), segment IDs corresponding to the segments 208A-C, and the anchor points 207A-D. The data 212 may also include one or more user preferences. For example, the user preferences may include an elevation gain limit, a child-friendliness rating, a dog-friendliness rating, services along the route (e.g., a service station every 30 miles), and other such user preferences.

The segment IDs (e.g., segment(1)-segment(3)) may be generated by the map application 204, being unique identifiers used only for the map 206. In other embodiments, each of the segments 207A-C may be associated with universal segment IDs, accessed from a central server (e.g., the computing system 120 in FIG. 1). Similarly, the anchor points identified in the data 212 (e.g., Anchor(1)-Anchor(4)) may correspond to a respective anchor point 208A-D.

The data 212 may also contain one or more types of requests, such as “convert to route,” “check route” or “optimize route” and process the data accordingly. For example, a “convert to route” may ensure check the various locations, segments, and/or anchor points to take the data and provide a route which may be navigated by a user. “Convert to route” may include additional information about the user and the mode of transportation (e.g., walking, hiking, or biking). “Check route” may include a checking process for the data 212 and may include checking whether provided segments, segments IDs, anchor points, and/or other route information is navigable or accessible.

“Navigable” with respect to a specific route segment may refer to whether that specific route segment may be traversed or used by a user. Navigability may be context dependent. For example, a route segment may not be navigable for a user on foot but when using an recreation vehicle the same route segment may be navigable. For example, a route segment across a desert dune may be navigable with a powered vehicle but not navigable on foot or on bicycle. Similarly, certain routes may be navigable on bicycle but not navigable on foot. Requests made to routing service 216 may further include the type or nature of transit to further identify whether the route is navigable. In some examples, a route segment may never be navigable at a certain time of year despite the mode of transit. For example, a route segment over a lake may only be navigable when it is determined that the lake is frozen over but not be navigable at any other time of the year. The same route segment may be considered to be navigable on a snowmobile or using skates but not navigable on foot. Whether or not a route segment is navigable may be a function of the type of transportation, time of day, weather, advisories, local rules, regulations, and laws, etc.

Various non-limiting examples of route segments which may be navigable or not navigable are provided herein. A route may not be considered navigable when a specific event prevents the route from being navigated. For example, a route may not “navigable” when there is an event such as a rockslide or a avalanche which prevents that specific route segment to be accessed. Another example of a not navigable route segment is when authorities close off a specific route segment. In this example, the not navigable route segment may later become navigable when authorities reopen the route segment. Another example of a not navigable route segment is during a particular event, such as a parade or protest, which prevents a user from navigating a particular route. An example of an event which may occur but leaves a route navigable may include a single fallen tree in a route segment, which may still be traversed. An example of a similar event which may leave an event unnavigable is a tree which has fallen on a bridge. As another example, a tree which has fallen on a bridge but where a small creek or stream may be traversed may still leave the specific route segment navigable (or, the specific bridge may be considered an unnavigable route segment with the use of a stream to be an alternative route segment). For example, if the mode of transportation selected was a bicycle, the route segment may be considered not navigable but if the mode of transportation selected was on foot, the same route segment may be considered navigable.

The map application 204 may transmit the data 212 to a computing system 220. The computing system 220 may be similar to the computing system 120 in FIG. 1 and include similar components and functionalities. Thus, the computing system may include one or more processors, computer-readable memories, and other such components. Some or all of the computing system 220 may be cloud-based systems and/or physical machines and devices. The computing system 220 may include a routing service 216. The routing service 216 may process the data 212 provided by map application 204. The routing service 216 may be configured to process the data 212, received from the map application 204 to generate actionable, navigable, and/or updated routes. The routing service 216 may also provide functionality including route calculation, dynamic route updates, data optimization, conversion to a navigable route, etc.

In FIG. 2C, the routing service 216 may access one or more datastores 230-233 in order to determine the navigability of the segments 208A-C. The one or more datastores 230-233 may include weather data 230, environmental data 231, historical user data 232, and map data 233. The datastores 230-233 may be included in one database or be distributed datastores. In some examples, the datastores 230-233 may differ in configuration and storage. For example, relational databases like PostgreSQL or MySQL may be used for structured data such as user accounts and historical navigation records, such as the historical user database 232. The map database 233 may use a NoSQL databases, which may be suited for handling large datasets of environmental data (e.g., the environment data 231) and/or semi-structured map data. Geospatial databases may be used for storing and querying geographical and spatial information.

The weather datastore 230 may be a database including upcoming or known weather conditions. The routing service 216 may utilize some or all of the information included in the weather datastore 230 to determine the accessibility and/or navigability of a particular segment, such as snow, sleet, hail, sleet, ice, rockslides, or other conditions. In some embodiments, the weather datastore 230 may include a real-time (or near real-time) datastore such as an internet weather prediction service.

The environmental data 231 may include time-series databases which may be continually updated data like traffic and environmental conditions. The environmental data 231 may include information about the environment such as terrain, foliage, and whether a particular segment is navigable at a particular time (e.g., scheduled winter closures, landslide activity, volcanic activity, etc.).

The historical user data 232 may include one or more routes (and/or segments thereof) and associated characteristics. For example, a user may indicate that a particular route is difficult and unsuitable for children. Another user may indicate that another route is good for dogs due to local regulations, etc. Other examples would be obvious to one of ordinary skill in the art. The historical user data 232 may also include local regulations and laws that may affect certain segments such as wildlife regulations, fire regulations, etc. The map data 233 may include one or more maps and/or layers thereof. The map data 233 may include topographical data, road maps, forestry maps, etc. The map data 233 may therefore be used to determine segments and routes between the anchor points 208A-D.

The routing service 216 may check each segment of the route (e.g., segment(1)) to determine whether a particular segment may be navigated. For example, the routing service 216 may determine that the segment 208A is inaccessible due to a winter storm warning in the area by accessing the weather data 230. The routing service 216 may determine that segment 208B is inaccessible due to fire closures based on the environmental data 231. The routing service 216 may also determine that the segment 207C is difficult (e.g., steep) based on the historical user data 232.

Then, as shown in FIG. 2D, the routing service 216 may generate a map (or route) 214. Although the map 214 is shown as a graphical representation of a route, it should be understood that the map 214 may be data including anchor points and segment IDs (e.g., the data 212). After determining that one or more of the segments 208A-C are inaccessible, the routing service 216 may use some or all of the data in the datastores 230-233 to generate a second route, as shown in the map 214. The routing service 216 may determine one or more replacement segments for any unnavigable segments of the segments 208A-C. The routing service 216 may perform a routing calculation to generate a new route. In generating the new route, the routing service 216 may attempt to minimize a difference between the route received (e.g., the segments in the received data) from the user device 202 and the new route. For example, the routing service may attempt to minimize a difference in a number of paths (or roads, highways, etc.), a number of segments, and/or other such components of the desired route. In some examples, the routing service 216 may ensure that at least one replacement route segments is contiguous with least a route segment which is determined to be navigable. For example, at least one replacement route segments may connect to a route segment which is already navigable. For example, if segment 208A and 208C are navigable, a replacement route segment for segment 208B may be such that it connects with segment 208A and/or segment 208C.

The map 214 (e.g., the new route) may still include the anchor points 207A-D, but with new segments 218A-C. The new segments 218A-C may be accessible (or navigable) according to the data in the datastores 230-233. Although the order in which the anchor points 207A-D are connected via the new segments 218A-C may be different than as connected by 208A-C, all of the anchor points 207A-D may still be included in the new route. In some embodiments, one or more of the anchor points 207A-D may not be accessible due to the lack of navigability of the segments 208A-C. Then the map 214 (e.g., the new route) may not include the inaccessible anchor points. Instead, a failure notification may be generated. Similarly, if a number above a certain threshold of the segments 208A-C are replaced by new segments 218A-C, a corresponding failure notification may be generated.

As shown in FIG. 2E, the routing service 216 may transmit data 222 to the user device 202. The data 222 may include a second route name (here, “Route B”), as well as data indicating the anchor points 207A-D, and segment IDs corresponding to the new segments 218A-C. The segment IDs may also include information indicating location information associated with the segment. For example, the segment 218A may have a segment ID of segment(1b). The segment 218A may be correlated with a particular road between the anchor point 207A and the anchor point 207B. The data 222 may therefore identify the particular road as well as the segment ID.

In various embodiments, the routing service 216 initially sends only a minimal set of route information, such as basic geometries, to minimize data use and enhance performance. Once a route is finalized or bandwidth is available, routing service 216 may send additional information, enriching the first set of route information with detailed navigational aids, including turn-by-turn instructions and relevant alerts.

After receiving the data 222, the user device 202 (and/or the map application 204) may utilize some or all of the data 222 to render the second map 214. The second map 214 may include the anchor points 207A-D and/or the new segments 218A-C. The second map 214 may also include one or more notifications (e.g., failure notifications) generated by the routing service 216.

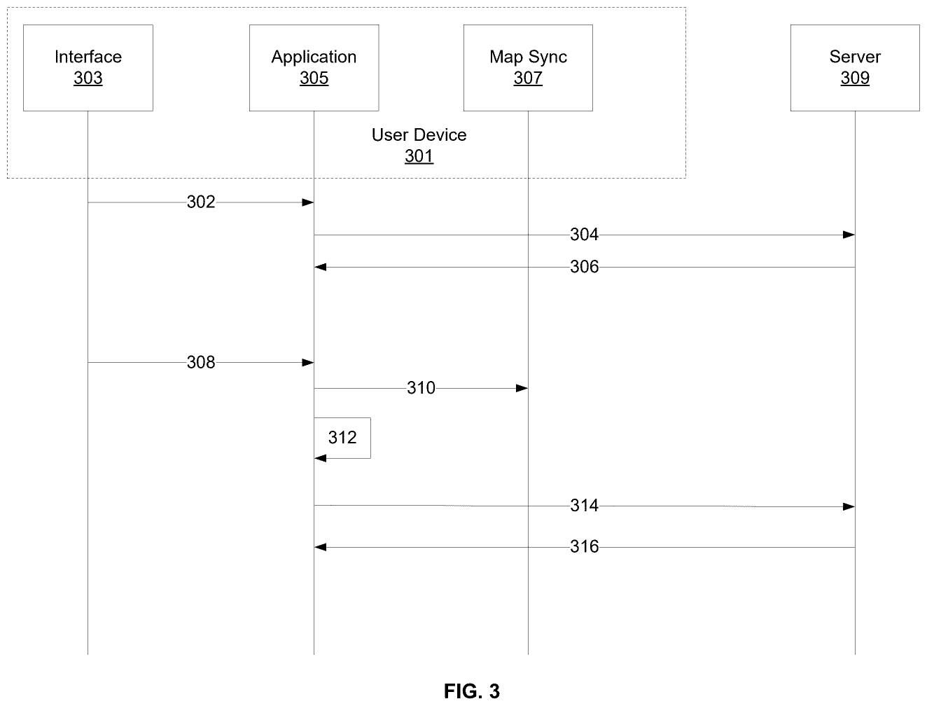

FIG. 3 illustrates a diagram of a workflow 300 for route management, according to certain embodiments. The workflow 300 may be performed by some or all of the systems and devices described herein. For example, the workflow 300 may be performed by the systems 100 and/or 200, working alone or in conjunction with each other. The steps of the workflow 300 may be performed in a different order than is shown and described, and/or some steps may be combined. In some embodiments, some steps may be skipped altogether.

One or more of the steps of workflow 300 may be performed by a user device 301 and/or a server 309. The user device 301 may contain an interface 303, an application 305, and a map synchronization (map sync) 307. The interface 303 may be any interface which enables a user to input information to the user device 301. For example, the interface 303 may enable a user to provide input via touchscreen, stylus, mouse or other peripheral device. The input may be correlated with viewing routes in a route library, selecting one or more saved routes, editing one or more elements of a map (e.g., appending anchor points, deleting anchor points, inserting anchor points, moving anchor points, etc.) and providing input to start a navigation of a route.

The application 305 may be any of the applications described herein with respect to systems 100 and/or 200, including for example, the map application 204. The application 305 may be configured to receive and transmit data to and from a map synchronization service (e.g., map sync 307) and/or server 309. The map sync 307 may be a background application executed on the user device 301 and configured to communicate between the application 305 and the server 309 (and/or services thereof). The map sync 307 may also perform background operations for the application 305 such as accessing live map data, hosting various algorithms, etc.

The server 309 may be a server configured to receive and transmit information to one or more user devices (e.g., the user device 301) and/or other computing devices. The server 309 may be similar to computing system 120 or computing system 220 in FIGS. 1 and 2A-2E. The server 309 may contain a routing service, similar to routing service 116 and/or routing service 216. Additionally, server 309 may include or access one or more datastores, such as the datastore 110 or other datastores (e.g., the datastores 230-233).

At step 302, the workflow 300 may include receiving a user an input via the interface 303. The input may be used to perform one or more operations. For example, an input may be received at interface 303 corresponding to an edit operation to an existing or new route. This may include, for example, appending an anchor point, deleting of one or more anchor points, inserting one or more anchor points, or transitioning and/or moving an anchor point, or changing the order of one or more anchor points. This information may be provided to the application 305 after input is received. In some examples, the edit operation may be performed on a route which was previously stored in the user device 301. In other examples, the edit operation may be arbitrarily performed to generate a new route without reference to any previously stored route.

The application 305 may also render and/or provide a route geometry based on the edits received. For example, the application 305 may provide or determine one or more segment IDs responsive to the edit operations which are made at this step. In other examples, the route geometry may not be updated based on the edit operations and/or changes to the anchor points. For example, specific segment IDs may not be available or known to the application 305 to perform an update responsive to the edit operations.

At step 304, the application 305 may transmit information corresponding to the input(s) the server 309. In some examples, the data transmitted to server 309 may be similar to data 112 or data 212. This may include anchor points, segment IDs, route geometry, and other such information. Step 302 may be used to generate a new route. Therefore, the server 309 (and/or map sync 307) may not have any information associated with the route generated at 302. Instead, the server 309 may generate a route to include all of the anchor points and inputs received from the user device 301 (or as many as possible). The route may be navigable at the time the server 309 generates the route.

At step 306, the server 309 may transmit the route and/or other data to user device 301 and/or the application 305. In some examples, the route may include one or more segment IDs corresponding to the route/inputs received at 302. The route may be stored by the application 305 in persistent data. The persistent data may be accessible directly by the map application 305 and/or the map sync 307. The persistent data may be a route library, including one or more previous received and/or generated routes.

At step 308, workflow 300 may include receiving an input at the interface 303 indicating a route selection. The input may indicate that the user wishes to begin the route received from the server 309. In some embodiments, the input may correspond to a selection made from the route library. The selected route may not be navigable, and/or require verification from the server 309. For example, the selected route may have been received by the user device 301 in the summer, but the selection made in the winter. Thus, some or all of the route may need to be verified by the server 309.

At step 310, the workflow 300 may the application 305 requesting the route from the map sync 307. The map synchronization service may access the persistent data (e.g., the route library) in order to fulfill the request. Then, at 312, the route (and/or data associated with the route) may be displayed on a display of the user device 301 (e.g., the map 206 in FIG. 2).

At step 314, the workflow 300 may include transmitting data from the application 305 to the server 309. The data may indicate the saved and/or selected route. The server 309 may validate some or all of the segments and/or anchor points indicated in the selected route. For example, a routing service may check each segment of the selected route to determine whether a particular segment may be navigated. For example, the routing service may determine that a segment is inaccessible due to a winter storm warning in the area by accessing the weather data (as described in FIG. 2C).

In some examples, the navigability may be determined based on checking each of the route segments and/or route IDs which may comprise the first route geometry for navigability. In some examples, when a specific route is not navigable, the server 309 may provide an alternative route by including alternative route segments and/or corresponding route IDs for route segments and/or route IDs which are not navigable from the first route geometry. These alternatives route segments (and corresponding segment IDs) and/or route IDs may be integrated into the first route geometry to create a navigable route. In some examples, the navigable route may be referred to as a second route.

At step 316, the workflow 300 may include transmitting a navigable route from a server 309 to the application 305. The navigable route may be transmitted as data, similar to the data 222. In generating the new route, the server 309 may attempt to minimize a difference between the selected route (e.g., the segments in the received data) from the user device 301 and the new route. For example, the routing service may attempt to minimize a difference in a number of paths (or roads, highways, etc.), a number of segments, and/or other such components of the desired route.

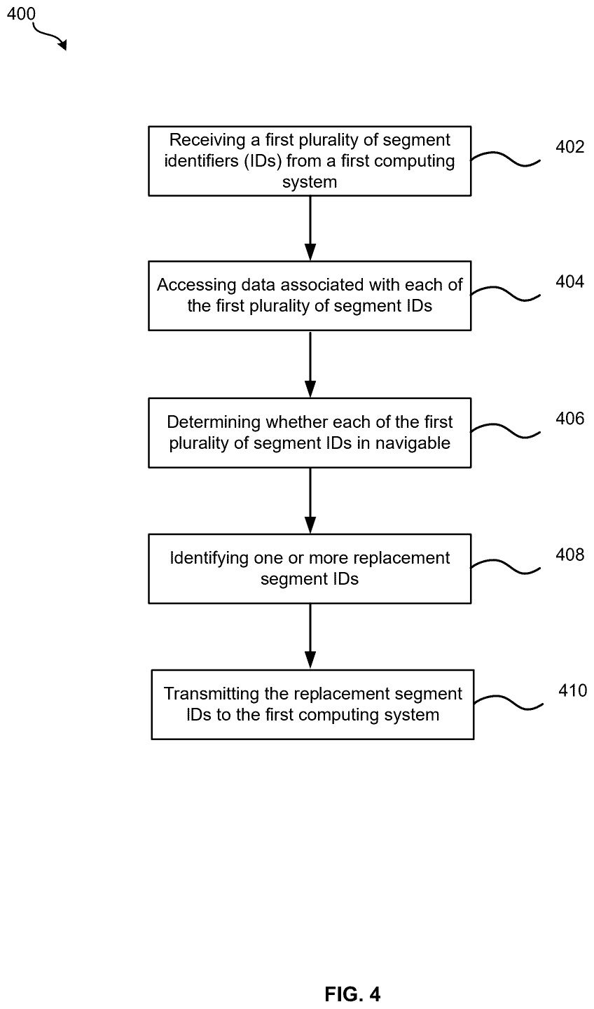

FIG. 4 illustrates a diagram of a method 400 for route management, according to certain embodiments, according to certain embodiments. The method 400 may be performed by some or all of the systems and devices described herein. For example, the method 400 may be performed by the systems 100 and/or 200, working alone or in conjunction with each other. The steps of the method 400 may be performed in a different order than is shown and described, and/or some steps may be combined. In some embodiments, some steps may be skipped altogether.

At step 402, the method 400 may include receiving, at a first computing system from a second computing system, a first plurality of route segments and/or segment identifiers (IDs) corresponding to a first route stored in the second computing system. The first computing system may be similar to the computing system 120 in FIG. 1. The second computing system may be similar to the user device 102 in FIG. 1. The segment IDs may be similar to the segment IDs 208A-C in FIGS. 2A-2E. Each segment ID may further contain sub-segments, or additional segments, which may be used for the routing after conversion to a navigable route. The segments 208A-208C may correspond to roads, paths, etc., or may be define a generally desired route. In some examples, each segment ID may correspond to a path between two anchor points and/or be based on the anchor points related to a path. In other examples, a segment ID may correspond to a smaller segment of the path taken between two anchor points. Each segment ID and/or route segment may be further subdivided as required for the required level of granularity for a particular route and/or based on requirements of a mapping application.

At step 404, the method may include accessing data associated with each of the first plurality of route segments and/or segment IDs. The data may be stored in one or more datastore, such as the datastores 230-233. The one or more datastores 230-233 may include weather data 230, environmental data 231, historical user data 232, and map data 233. For example, the weather datastore 230 may be a database including upcoming or known weather conditions. As another example, the environmental data 231 may include information about the environment such as terrain, foliage, and whether a particular segment is navigable at a particular time (e.g., scheduled winter closures, landslide activity, volcanic activity, etc.). In this manner, the information from one or more datastores may be accessed in connection with the plurality of segment IDs.

At step 406, the method may include determining whether each of the first plurality of route segments and/or segment IDs in navigable. This may be based on at least in part on the data associated with each of the segment IDs. For example, the data associated with each of the segment IDs may include information which is contained in datastores 230-233. As one example, the first route may have contained an estimation of a navigable route, which may contain corresponding estimations of navigable segment IDs. As this process does not ensure that the segment IDs are navigable, the first plurality of segment IDs The routing service 216 may utilize some or all of the information included in one or more datastores to make a determination of the navigability of the segment IDs. For example, weather datastore 230 may be used to determine the accessibility and/or navigability of a particular segment, such as snow, sleet, hail, sleet, ice, rockslides, or other conditions.

At step 408, the method may include identifying by the first computing system at least one replacement route segments and/or replacement segment ID. The identification may be made responsive to a determination that at least one of the first plurality of segment IDs is not navigable. The replacement segment IDs may include for example, segments 218A-218C. The replacement segments 218A-C may be accessible (or navigable) according to the data in the datastores 230-233. Although the order in which the anchor points 207A-D are connected via the new replacement segment IDs (e.g., segments 218A-C which may be different than as connected by 208A-C,) all of the anchor points 207A-D may still be included in the new route. In some examples, no replacement segment IDs need to be provided if no re-routing is required and a check of the segment IDs indicates that the route is navigable.

At step 410, the second route comprising the replacement route segment and/or replacement segment ID may be transmitted. The transmission may occur by the first computing system and to the second computing system. In some examples, the transmission may contain additional information related to the replacement segment IDs. For example, information may relate to time-based accessibility information for a subset of the replacement segment IDs. This may provide information on when the route may be navigable. In other examples, such as due to replacement of some of the segment IDs during a weather related closure, the expected time till the weather related closure may be cleared may be indicated. In some examples, the replacement segment IDs may be alternatives. In some examples, the information transmitted at step 410 may include reasons for why the first plurality of segment IDs may not be navigable.

The replacement segment IDs may also be visually displayed on the screen of a second computing system (e.g., the user device 102). The visual display may include displaying in a color coded manner the reason a segment ID from the first plurality of segment IDs was not navigable. In some examples, a view may be contained on an application (e.g., the map application 204) which only highlights differences between the first set of segment IDs and route created due to the replacement segment IDs.

In various embodiments, the replacement route segments and/or segment IDs may contain additional metadata which identifies time-based information related to the navigability of the route. Thus, if a user initiates the route at a later date, the time-based information may be used to determine if the route is navigable at the time the user decides to initiate navigation of the route. Other metadata information may include warning conditions which may be related to weather, terrain, or foliage of the first plurality of segment IDs or the replacement segment IDs. Information related to the mode of transportation may also be included when transmitted from the second computing system to the first computing system.

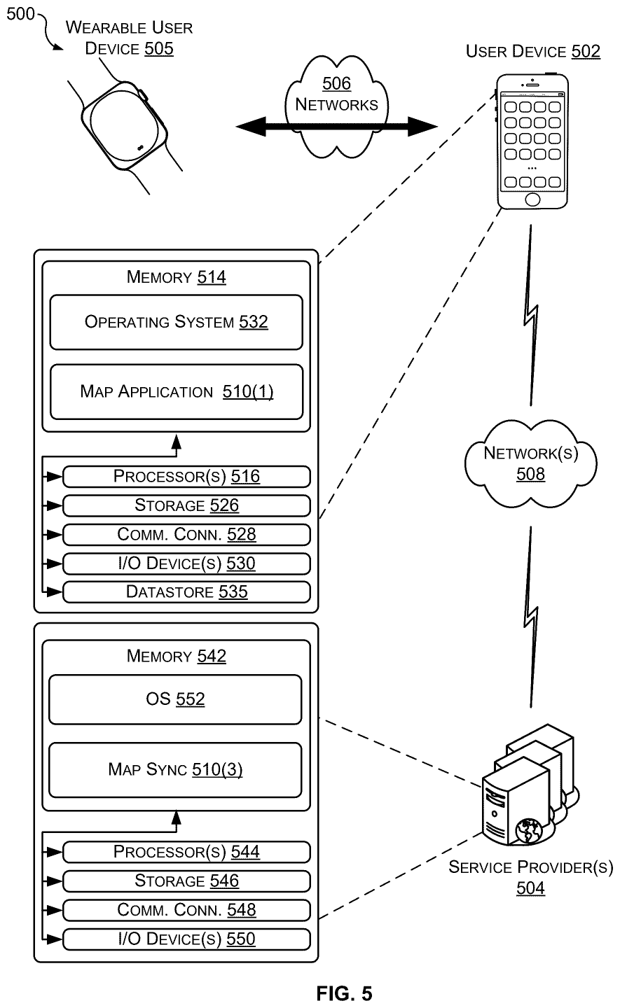

FIG. 5 illustrates an example architecture or environment 500 configured to implement techniques relating to providing route management, according to certain embodiments. In some examples, the example architecture 500 may further be configured to enable a user device 502 (e.g., the user device 102), the service provider computers 504 (e.g., the service provider 504), and a wearable electronic device 505 (e.g., an example accessory deice) to share information. In some examples, the devices may be connected via one or more networks 508 and/or 506 (e.g., via Bluetooth, WiFi, the Internet, or the like). In the architecture 500, one or more users may utilize the user device 502 to manage, control, or otherwise utilize the wearable electronic device 505, via the one or more networks 506. Additionally, in some examples, the wearable electronic device 505, the service provider computers 504, and the user device 502 may be configured or otherwise built as a single device. For example, the wearable electronic device 505 and/or the user device 502 may be configured to implement the examples described herein as a single computing unit, exercising the examples described above and below without the need for the other devices described.

In some examples, the networks 506, 508 may include any one or a combination of many different types of networks, such as cable networks, the Internet, wireless networks, cellular networks, satellite networks, other private and/or public networks, or any combination thereof. While the illustrated example represents the user device 502 accessing the service provider computers 504 via the networks 508, the described techniques may equally apply in instances where the user device 502 interacts with the service provider computers 504 over a landline phone, via a kiosk, or in any other manner. It is also noted that the described techniques may apply in other client/server arrangements (e.g., set-top boxes, etc.), as well as in non-client/server arrangements (e.g., locally stored applications, peer to peer configurations, etc.).

The user device 502 may be any type of computing device such as, but not limited to, a mobile phone, a smartphone, a personal digital assistant (PDA), a laptop computer, a desktop computer, a thin-client device, a tablet computer, a wearable device, or the like. In some examples, the user device 502 may be in communication with the service provider computers 504 via the networks 508, 506, or via other network connections.

In one illustrative configuration, the user device 502 may include at least one memory 514 and one or more processing units (or processor(s)) 516. The processor(s) 516 may be implemented as appropriate in hardware, computer-executable instructions, firmware, or combinations thereof. Computer-executable instruction or firmware implementations of the processor(s) 516 may include computer-executable or machine-executable instructions written in any suitable programming language to perform the various functions described. The user device 502 may also include geo-location devices (e.g., a global positioning system (GPS) device or the like) for providing and/or recording geographic location information associated with the user device 502.

The memory 514 may store program instructions that are loadable and executable on the processor(s) 516, as well as data generated during the execution of these programs. Depending on the configuration and type of the user device 502, the memory 514 may be volatile (such as random access memory (RAM)) and/or non-volatile (such as read-only memory (ROM), flash memory, etc.). The user device 502 may also include additional removable storage and/or non-removable storage 526 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 514 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 514 and the additional storage 526, both removable and non-removable, are all examples of non-transitory computer-readable storage media. For example, non-transitory computer readable storage media may include volatile or non-volatile, removable or non-removable media implemented in any process or technology for storage of information such as computer-readable instructions, data structures, program modules, or other data. The memory 514 and the additional storage 526 are both examples of non-transitory computer storage media. Additional types of computer storage media that may be present in the user device 54 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 502. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 502 may also contain communications connection(s) 528 that allow the user device 502 to communicate with a data store, another computing device or server, user terminals, and/or other devices via the networks 508, 506. The user device 502 may also include I/O device(s) 530, such as a keyboard, a mouse, a pen, a voice input device, a touch input device, a display, an operating system 532 and/or one or more application programs or services for implementing the features disclosed herein including a map application 510 (1). In some examples, the map application 510 (1) may be configured to implement the features described herein such as those described with reference to the flowcharts. User device 502 may also include a Datastore 535. The Datastore 535 may be a separate memory partition within the memory 514 or may be an individual hardware component of the user device 502. The Datastore 535 may be configured as a sensitive data Datastore, and may not be accessible to a user of the user device 502.

The service provider computers 504 may also be any type of computing device such as, but not limited to, a mobile phone, a smartphone, a PDA, a laptop computer, a desktop computer, a thin-client device, a tablet computer, a wearable device, a server computer, a virtual machine instance, etc. In some examples, the service provider computers 504 may be in communication with the user device 502 and/or the wearable user device 505 via the networks 508, 506, or via other network connections.

In one illustrative configuration, the service provider computers 504 may include at least one memory 552 and one or more processing units (or processor(s)) 544. The processor(s) 544 may be implemented as appropriate in hardware, computer-executable instructions, firmware, or combinations thereof. Computer-executable instruction or firmware implementations of the processor(s) 544 may include computer-executable or machine-executable instructions written in any suitable programming language to perform the various functions described.

The memory 552 may store program instructions that are loadable and executable on the processor(s) 544, as well as data generated during the execution of these programs. Depending on the configuration and type of service provider computer 504, the memory 552 may be volatile (such as RAM) and/or non-volatile (such as ROM, flash memory, etc.). The service provider computer 504 may also include additional removable storage and/or non-removable storage 546 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 552 may include multiple different types of memory, such as SRAM, DRAM, or ROM. While the volatile memory described herein may be referred to as RAM, any volatile memory that would not maintain data stored therein once unplugged from a host and/or power would be appropriate. The memory 552 and the additional storage 546, both removable and non-removable, are both additional examples of non-transitory computer-readable storage media.

The service provider computer 504 may also contain communications connection(s) 548 that allow the service provider computer 504 to communicate with a data store, another computing device or server, user terminals and/or other devices via the networks 508, 506. The service provider computer 504 may also include I/O device(s) 550, such as a keyboard, a mouse, a pen, a voice input device, a touch input device, a display, speakers, a printer, etc. The memory 552 may include an operating system 552 and/or one or more application programs or services for implementing the features disclosed herein including the map sync 510 (3). This version of the sensitive data application may be configured to perform similar operations as the map application 510 (1). Thus, in some examples, the map sync 510 (3) may be configured to implement the features described herein such as those described with reference to the flowcharts.

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

As described above, one aspect of the present technology is the gathering and use of data available from specific and legitimate sources to improve routing of stored routes by checking if they are navigable. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information. The present disclosure recognizes that the use of such personal information data, in the present technology, can be used to the benefit of users.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of customized routes, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app related to navigation or downloading routes that their personal information data may be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain financial applications, data de-identification can be used to protect a user's privacy and/or sensitive data. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

What is claimed is:

1. A method for route management, performed by a first computing system, the method comprising:
receiving, at the first computing system from a second computing system, a first route comprising a corresponding plurality of route segments stored at the second computing system;
accessing, by the first computing system, data associated with each of the corresponding plurality of route segments, the data associated with each of the corresponding plurality of route segments stored at the first computing system;
determining, based at least in part on the data associated with each of the corresponding plurality of route segments, whether each of the corresponding plurality of route segments is navigable;
in accordance with a determination that at least one of the corresponding plurality of route segments is not navigable, identifying, by the first computing system, a replacement route segment for the at least one of the corresponding plurality of route segments that is not navigable; and
transmitting, by the first computing system, a second route to the second computing system, the second route comprising the replacement route segment.

2. The method of claim 1, further comprising: in accordance with a determination that a threshold amount of the first route is navigable, transmitting, by the first computing system, route validation data to the second computing system, the route validation data configured to validate the navigability of the first route.

3. The method of claim 1, wherein the replacement route segment is contiguous with at least one of the route segments of the first route.

4. The method of claim 1, wherein the first computing system identifies time-based information and/or location-based information related to navigability of the replacement route segment.

5. The method of claim 4, wherein the time-based information identifies time-based closures of one or more of the replacement route segments.

6. The method of claim 4, wherein the location-based information comprises one or more warning conditions related to at least one of weather, terrain, or foliage of one or the replacement route segment.

7. The method of claim 1, further comprising determining, by the second computing system, whether a difference exists between the first route stored in the second computing system and the second route received from the first computing system.

8. A system, comprising:
one or more processors;
a computer-readable memory comprising instructions that, when executed by the one or more processors, cause the one or more processors to perform operations to:
receive, by a first computing system and from a second computing system, a first route comprising a corresponding plurality of route segments stored at the second computing system;
access, by the first computing system, data associated with each of the corresponding plurality of route segments, the data associated with each of the corresponding plurality of route segments stored at the first computing system;
determine, based at least in part on the data associated with each of the corresponding plurality of route segments, whether each of the corresponding plurality of route segments is navigable;
in accordance with a determination that at least one of the corresponding plurality of route segments is not navigable, identifying, by the first computing system, a replacement route segment for the at least one of the corresponding plurality of route segments that is not navigable; and
transmit, by the first computing system, a second route to the second computing system, the second route comprising the replacement route segment.

9. The system of claim 8, further comprising visually displaying, on a screen of the second computing system, differences between the segment IDs stored on the second computing system and the segment IDs received from the first computing system.

10. The system of claim 8, further comprising determining a percentage difference in the first route stored in the second computing system and the second route received from the first computing system.

11. The system of claim 10, further comprising displaying, on the second computing system, an alert when the percentage difference is larger than a threshold.

12. The system of claim 8, wherein each route segment corresponds to a unique segment identifier (ID).

13. The system of claim 8, wherein the instruction further cause the system to generate, by the second computing system a new route based at least in part on segment IDs received from the first computing system.

14. A non-transitory computer-readable medium comprising instructions that, when executed by one or more processors, cause the one or more processors to perform operations comprising:
receiving, at a first computing system and from a second computing system, a first route comprising a corresponding plurality of route segments stored at the second computing system;
accessing, by the first computing system, data associated with each of the corresponding plurality of route segments, the data associated with each of the corresponding plurality of route segments stored at the first computing system;
determining, based at least in part on the data associated with each of the corresponding plurality of route segments, whether each of the corresponding plurality of route segments is navigable;
in accordance with a determination that at least one of the corresponding plurality of route segments is not navigable, identifying, by the first computing system, a replacement route segment for the at least one of the corresponding plurality of route segments that is not navigable; and
transmitting, by the first computing system, a second route to the second computing system, the second route comprising the replacement route segment.

15. The non-transitory computer-readable medium of claim 14, wherein the second computing system renders a new visual representation of the new route.

16. The non-transitory computer-readable medium of claim 15, wherein the new visual representation highlights the differences in the first route and the second route.

17. The non-transitory computer-readable medium of claim 14, wherein segment IDs are transmitted and received between the first computing system and the second computing system in lieu of route segments.

18. The non-transitory computer-readable medium of claim 14, wherein the second computing system transmits information related to a mode of transportation to the first computing system.

19. The non-transitory computer-readable medium of claim 18, wherein determination of whether a route segment is navigable is based on at least the mode of transportation transmitted to the first computing system.

20. The non-transitory computer-readable medium of claim 14, wherein each route segment corresponds to a unique segment identifier (ID).
